(19) United States
(12) Patent Application Publication
(10) Pub. No.: US 2021/0291578 A1
(43) Pub. Date: Sep. 23, 2021

(54) COLOR PENCIL/PEN HOLDER

(71) Applicant: Biju Dhanapalan, Singapure (SG)

(72) Inventor: BIJU DHANAPALAN, Singapure (SG)

(21) Appl. No.: 17/261,924

(22) PCT Filed: Jul. 26, 2019
(86) PCT No.: PCT/IB2019/056392

§ 371 Date: Jan. 21, 2021

(30) Foreign Application Priority Data
Jul. 30, 2018 (IN) 201841028648

(51) Int. Cl. B43K 23/06

(52) U.S. Cl. CPC B43K 23/06

(57) ABSTRACT

The present invention provides a holder for holding writing instruments comprising individual units consisting of a pivot, a circular peg on one side of the unit and a circular hole on the other side of the unit, wherein each unit of the said holder moves through an opening angle and wherein the opening angle is dependent on the difference of the radii of the circular hole and the peg and is collapsible when packaged.

### RELATED APPLICATION

This application is related to Indian Provisional Application 201841028648 filed on 30 Jul. 2018 and is incorporated herein in its entirety.

### FIELD OF THE INVENTION

This invention provides a holder for holding writing instruments such as pencil, pen, color pencil, color pen, sketch pen or any writing instrument.

### BRIEF DESCRIPTION OF DRAWINGS

FIG. 1. Visual representation of the pencil/pen holder.

FIG. 2. Visual representation of the pegs.

FIGS. 3a and 3b are working figures of a peg showing the relationship between Radius distance between the pivot and the hole/peg, the total angle through which the design opens (180 degrees in the rendering), and the number of pencils.

FIG. 4 shows the working figure of the peg at an opening angle.

### SUMMARY OF THE INVENTION

The present invention provides a holder for holding writing instruments in large numbers and is collapsible when packaged.

In one aspect the invention provides a holder for holding writing instruments comprising individual units consisting of a pivot, a circular peg on one side of the unit and a circular hole on the other side of the unit wherein the said holder holds as many writing instruments as the number of units created and is collapsible when packaged.

Each unit of the holder of the invention moves through an opening angle before pulling long and lifting the next unit to implement a domino effect. The implementation of the domino effect comprises pushing the circular peg of one unit into the circular hole of the adjacent unit. In another aspect, the invention provides a holder for holding writing instruments comprising individual units consisting of a pivot, a circular peg on one side of the unit and a circular hole on the other side of the unit, wherein each unit of the said holder moves through an opening angle and wherein the opening angle is dependent on the difference of the radii of the circular hole and the peg and wherein the relationship between the radii, distance between the pivot and the hole or peg, the total angle through which the design opens and the number of writing instrument is as follows:

$$\frac{R - r}{d} = sin \frac{θ}{2 N}$$

### Wherein:

R is the radius of the hole;
r is the radius of the peg;
d is the distance between the pivot and the center of the hole;
θ is the total angle through which the design opens which is different from the opening angle;
N is the total number of units over which the desired angle opens up.

Furthermore, the peg's center is positioned at a distance (b) from the hole's center in a direction that is perpendicular to the line connecting the pivot and the center of the hole and the distance between the said two centers (α) is given by the formula:

$$b = R - r = d \times sin \frac{θ}{2 N}$$

### DETAILED DESCRIPTION

The present invention provides a holder for holding writing instruments such as pencils, color pencils or pens. It is a collapsible holder when packaged and can serve as a display system upon opening. The utility of the invention is that it can hold any number of writing instruments in order and is collapsible.

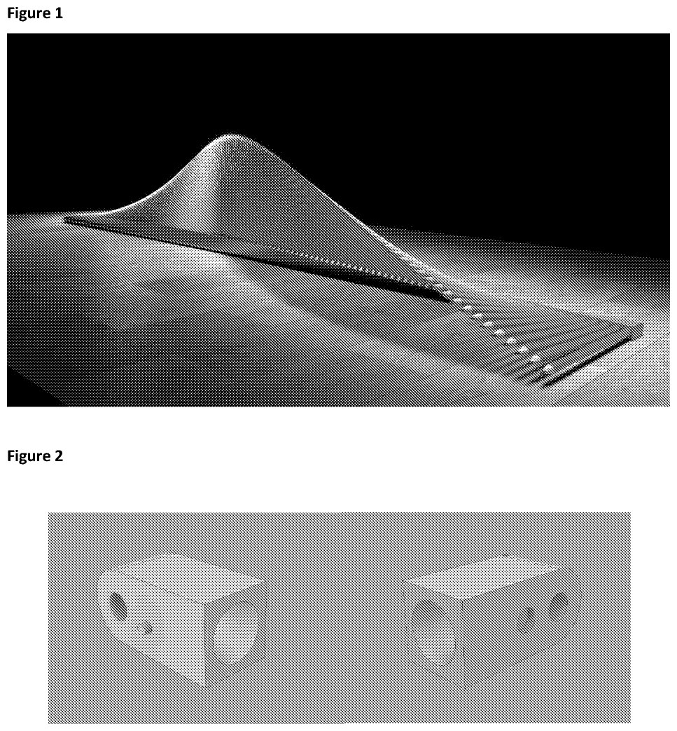

FIG. 1 provides the visual representation of the pencil/pen holder.

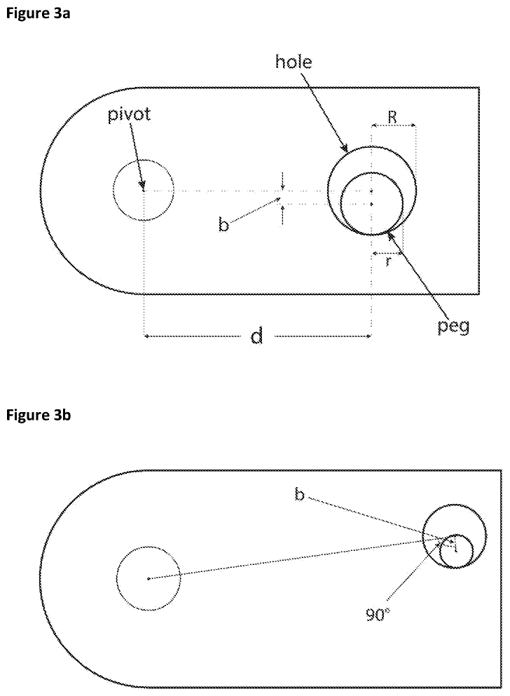

FIG. 1 shows a holder that can hold 120 pencils and opens over 180°. The ‘spine’ of the design consists of 120 units that each hold a pencil and allow the pencils to open up with a gradual change in the angle across the length of the spine. The spine, as meant in this invention, is the collection of the individual units, In this case 120 pieces) held together by a rod running through all the pieces' pivoting axis. The pivot position is shown in FIG. 3a. A point to be noted is that all these units are identical.

The basic principle is that each unit, when lifted, moves through a small (precisely calculated) angle before pulling long and lifting the next unit which then continues with a domino effect.

The implementation of the opening leading to the domino effect consists of a circular peg (FIG. 2) on one side of the individual unit and a circular hole on the other side of the unit. The peg from the next unit can be pushed into this hole such that the two units' faces are flushed together. The opening angle (the angle through which each peg moves before pulling along the next unit) depends on the difference of the radii of the hole and the peg wherein the hole always has a slightly larger radius. The relationship between the radii, the distance of the hole and peg from the pivot of the units, and the opening angle is highlighted below.

Since the opening angle is so heavily dependent on the radii of the hole and peg being so minutely different, a very high precision is required while manufacturing/machining the units. Precise circular holes (and pegs) are easiest to manufacture when working with a Computer Numerical Control (CNC) machining.

The relationship between the radii, distance between the pivot and the hole/peg, the total angle through which the design opens (180 degrees in the rendering), and the number of pencils is as follows and FIGS. 3a and 3b briefly describe it:

$$\frac{R - r}{d} = sin \frac{θ}{2 N}$$

### Where:

R is the radius of the hole
r is the radius of the peg
d is the distance between the pivot and the center of the hole
θ is the total angle through which the design opens (different from the opening angle as defined earlier)
N is the total number of units over which the desired angle opens up

The peg's center is positioned at a distance (b) from the holes center in a direction that is perpendicular to the line connecting the pivot and the center of the hole. The distance between the two centers (α) is given by the formula:

$$b = R - r = d \times sin \frac{θ}{2 N}$$

With the same variable declarations as above.

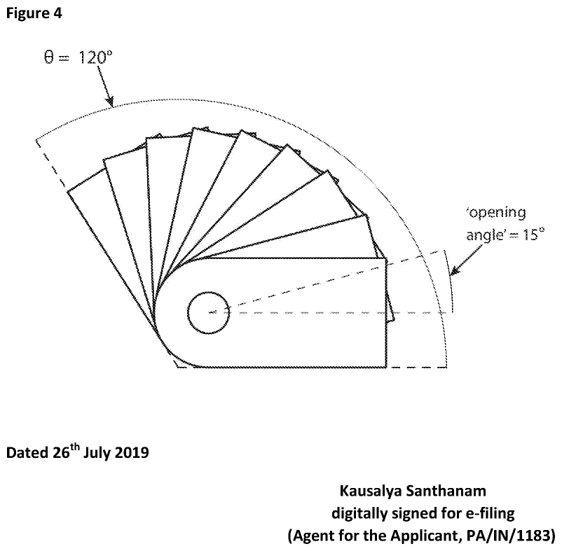

The difference between theta and the ‘opening angle’ is highlighted in the image below. The image shows the profile of 9 units opening through 120° totally (θ) and each having an ‘opening angle’ of 15° (FIG. 4).

What is claimed is:

1. A holder for holding writing instruments comprising individual units consisting of a pivot, a circular peg on one side of the unit and a circular hole on the other side of the unit wherein the 5 said holder holds as many writing instruments as the number of units created and is collapsible when packaged.

2. The holder for holding writing instruments as claimed in claim 1 wherein each unit of the said holder moves through an opening angle before pulling long and lifting the next unit to implement a domino effect.

3. The holder for holding writing instruments as claimed in claim 2 wherein the implementation of the domino effect comprises pushing the circular peg of one unit into the circular hole of the adjacent unit.

4. The holder for holding writing instruments as claimed in claim 2 wherein the opening angle is dependent on the difference of the radii of the circular hole and the peg.

5. The holder for holding writing instruments as claimed in claim 2 wherein the opening angle of the circular hole has larger radius than the radius of the peg.

6. A holder for holding writing instruments comprising individual units consisting of a pivot, a circular peg on one side of the unit and a circular hole on the other side of the unit, wherein each unit of the said holder moves through an opening angle and wherein the opening angle is dependent on the difference of the radii of the circular hole and the peg and wherein the relationship between the radii, distance between the pivot and the hole or peg, the total angle through which the design opens and the number of writing instrument is as follows:
$$\frac{R - r}{d} = sin \frac{θ}{2 N}$$
wherein:
R is the radius of the hole;
r is the radius of the peg;
d is the distance between the pivot and the center of the hole;
θ is the total angle through which the design opens which is different from the opening angle;
N is the total number of units over which the desired angle opens up.

7. A holder for holding writing instruments comprising individual units consisting of a pivot, a circular peg on one side of the unit and a circular hole on the other side of the unit, wherein the peg's center is positioned at a distance (bl from the hole's center in a direction that is perpendicular to the line connecting the pivot and the center of the hole and wherein the distance between the said two centers (a) is given by the formula:
$$b = R - r = d \times sin \frac{θ}{2 N}$$

8. The holder for holding writing instruments as claimed in claim 1, wherein the said writing instrument is selected from the group consisting of pencil, pen, color pencil, color pen and sketch pen.
